(19) United States
(12) Patent Application Publication
(10) Pub. No.: US 2001/0038475 A1
(43) Pub. Date: Nov. 8, 2001

(54) Synchronous digital communications system

(76) Inventor: Michael Joachim Wolf, Mundelsheim (DE)

Correspondence Address: SUGHRUE MION, ZINN, MACPEAK & SEAS, PLLC, 2100 Pennsylvannia Avenue, N.W., Washington, DC, 20037-3213, US

(21) Appl. No.: 09/729,781

(22) Filed: Dec. 6, 2000

(30) Foreign Application Priority Data
Dec. 11, 1999 (DE) 199 59 803.7

(51) Int. Cl. H04J 14/02

(52) U.S. Cl. 359/124; 359/110

(57) ABSTRACT

The synchronous digital communications system according to the invention serves to transmit electric signals optically. The electric signals to be transmitted are converted from electrical to optical form (E/O1, E/O2, E/On) and are transmitted using wavelength division multiplexing (WDM) or dense wavelength division multiplexing (DWDM). At least one nonswitched auxiliary channel is created using at least one wavelength (λ₁). Over the auxiliary channel, synchronization signals, in particular, are transmitted, but also maintenance and management signals. This has the advantage that independently of the switched communication links, synchronization is constantly ensured throughout the network. Each network element (NE1, NE2, NE3) has at least one interface unit that is reserved for synchronization and that continuously receives signals at the wavelength (λ₁) reserved for synchronization.

This invention relates to a synchronous digital communications system as set forth in the preamble of claim 1 and to a method of optically transmitting electric signals as set forth in the preamble of claim 7.

A synchronous digital communications system is based, for example, on a standard for synchronous digital hierarchy (SDH/SONET standard). In such a digital communications system, individual network elements are interconnected by different transmission media (e.g., copper cables, optical fiber waveguides, or radio links). A network element is, for example, an exchange for a public switched telephone network, a cross-connect, or an add/drop multiplexer. To synchronize the network elements, two techniques are known: master-slave synchronization and mutual synchronization.

The master-slave technique, also referred to as hierarchical synchronization, uses a unique primary reference clock for synchronization of a first hierarchical level of network elements, also referred to as nodes. These nodes give their derived clocks to the next level nodes, and so on. In the mutual level interconnected by the existing digital links. Each node calculates a mean phase value of the incoming clocks and its own internal clock.

From DE 44 46 511 it is known to avoid timing loops by grouping interface units of each network element that are used for synchronization in two classes, thereby defining a synchronization hierarchy. The interface units of one of the classes ignore received synchronization signals, and the interface units of the other class transmit synchronization signals (clock references).

Network elements have a number of interface units, which generally all serve to receive and transmit information signals, i.e., speech, data. Some predefined interface units additionally serve to receive and/or transmit synchronization signals. All-electric synchronous digital communications systems have nonswitched physical connections. A synchronization hierarchy is defined by predetermined paths. If section-by-section radio or optical point-to-point transmission is used, the electric signals (information+synchronization) are switched through transparently, i.e., one wavelength, for example, is reserved for each optical channel. The optical channel is implemented with a nonswitched optical connection. In this way, the network element interface units used for synchronization always receive the necessary synchronization signals. Even if no information is transmitted in the meantime, the connections between the network elements are maintained, for example by transmitting default messages, so that continuous synchronization is ensured.

A new situation arises if during section-by-section optical transmission, no time-invariable through-switching takes place. Then, optical connections are no longer permanently assigned to wavelengths. A flexible and time-variable assignment of optical channels to wavelengths is possible. For example, an optical channel for transmitting a first message packet is implemented by a first switched optical connection using a first wavelength, and an optical channel for transmitting a second message packet is implemented by a second switched optical connection using a second wavelength. If network elements with switching properties, such as optical cross-connects, are used in conjunction with wavelength-division multiplexing, arbitrary, time-variable optical channels can be created for transmitting information signals, such as SDH or SONET signals. For example, a first optical connection for creating a first optical channel is used in a first time period to transmit messages from a first network element to a second network element, with an optical cross-connect interposed between the network elements. The first optical connection is implemented using a first wavelength, for example. Via the interface unit assigned to the first wavelength, the second network element synchronizes itself, i.e., the synchronization clock, which corresponds to a bit-rate clock, is used for all interface units of the second network element. If in a second time period, the optical cross-connect uses the first wavelength for a second optical connection to create a second optical channel for transferring information from the first network element to a third network element, the connection to the second network element via the frist wavelength is interrupted. The second network element can no longer synchronize itself in the second time period. Even if the second network element received information and/or synchronization signals over a second or third optical connection, it could not synchronize itself, because only the interface unit assigned to the first wavelength is reserved for the purpose of accomplishing synchronization for all interface units. Instead of using one interface unit, synchronization can also be achieved using two or three interface units, for example by means of an additional selection facility that selects the clock of the best quality. Through the use of three interface units for synchronization purposes in conjunction with three wavelengths, the probability that no synchronization is possible can be minimized but cannot be reduced to zero.

The invention proposes a synchronous digital communications system as set forth in claim 1 and a method of optically transmitting electric signals as set forth in claim 6.

The synchronous digital communications system serves to transmit electric signals optically. The electric signals to be transmitted are converted from electrical to optical form and are then transmitted using wavelength-division multiplexing (WDM) or dense wavelength-division multiplexing (DWDM). At least one nonswitched auxiliary channel is reserved for the transmission of synchronization signals in particular. This has the advantage that synchronization is ensured throughout the system independently of the switched communication links. Each network element has one interface unit which is reserved for synchronization and which constantly receives signals on the wavelength reserved for synchronization. The auxiliary channel can additionally be used to transmit maintenance and management signals, whereby optimum utilization of its capacity can be achieved.

The synchronous digital communications system comprises, for example, at least three network elements interconnected by optical lines, each of the network elements comprising at least one electrical-to-optical converter and at least one optical-to-electrical converter. At least one optical cross-connect is connected between the network elements. Each optical cross-connect is adapted to switch optical connections using individual wavelengths for routing signals from one network element to another, with the at least one auxiliary channel being not usable for the switched optical connections. The cross-connect performs switching operations for optical connections for creating optical channels. However, the cross-connect is limited to the existing wavelengths less the wavelengths reserved for the at least one auxiliary optical channel, i.e., for synchronization in particular.

In a preferred embodiment, the synchronous digital communications system comprises at least three network elements designed as SDH or SONET elements that are interconnected by optical lines. Between the network elements, hierarchical synchronization is implemented by the creation of the at least one auxiliary channel for transmitting a synchronization clock generated in a primary reference source, and clocks derived therefrom, over predetermined paths. For example, a reference clock generated in a first network element is transmitted for synchronization purposes over a first reserved and nonswitched optical connection to a second network element using a first wavelength. A clock derived in the second network element from the received reference clock is transmitted over a second reserved and nonswitched optical connection to a third network element using a second wavelength. Between the first and second network elements, the first wavelength is then reserved exclusively for the transmission of auxiliary signals, such as synchronization signals, maintenance signals, and management signals, and cannot simultaneously be used for the transmission of information, such as data. All other available wavelengths, e.g., twenty wavelengths, can be used for the transmission of information signals. Between the second and third network elements, the second wavelength is then reserved for the transmission of auxiliary signals, such as synchronization signals, and cannot simultaneously be used for the transmission of information. All other available wavelengths, e.g., the first and the third through the twentieth wavelengths, can be used for the transfer of information signals. Synchronization is guaranteed throughout the system.

Alternatively to hierarchical synchronization, the invention can also be used with mutual synchronization. The synchronous digital communications system comprises at least three network elements designed as SDH or SONET elements that are interconnected by optical lines. Between the network elements, mutual synchronization is implemented by the creation of the at least one auxiliary optical channel for transmitting at least one synchronization clock generated in at least one primary reference source over predetermined paths. In each of the paths, at least one selected wavelength is used exclusively for the transmission of auxiliary signals, such as synchronization signals, maintenance signals, and management signals. Thus, there is at least one nonswitched auxiliary optical channel on each link between two network elements that is used for synchronization distribution, this auxiliary channel serving particularly synchronization purposes and not to transfer information.

In another preferred embodiment of the invention, the synchronous digital communications system comprises at least three network elements as well as a synchronization manager and a connection manager, the network elements being interconnected by optical lines. The synchronization manager is adapted to configure dedicated synchronization links between the three network elements over the at least one auxiliary channel. The connection manager is adapted to configure communications links over switched optical connections which do not include the at least one auxiliary channel. The synchronization manager and the connection manager perform network management functions. During system design, the number of network elements, the number of possible optical connections, etc. are determined. For the synchronization, a topology is defined in the synchronization manager. For instance, master-slave synchronization is chosen. To implement this synchronization, the necessary paths are determined. The paths are established as nonswitched auxiliary optical channels. Each auxiliary channel is assigned a particular wavelength, for example. In each network element, at least one interface unit is selected for synchronization. Each of the selected interface units is assigned the wavelength of the respective auxiliary channel. On this wavelength, only auxiliary signals, such as synchronization signals, maintenance signals, and management signals, may be transmitted. After completion of the configuration of the synchronization links, the configuring of the communication links takes place. Information, such as data packets, is transmitted over switched communication links which must not overlap the synchronization links, i.e., the at least one auxiliary optical channel, at any time. Therefore, the wavelengths reserved for the synchronization links cannot be used by the connection manager.

In the novel method of optically transmitting electric signals, the electric signals to be transmitted are converted from electrical to optical form and then transmitted using wavelength-division multiplexing, with at least one nonswitched auxiliary optical channel being created using at least one wavelength, this auxiliary channel being reserved for the transmission of synchronization signals in particular. The method can be used in a synchronous communications system comprising at least three network elements interconnected by optical lines. Dedicated synchronization links over the at least one auxiliary channel are then connected between the at least three network elements for the exclusive transmission of at least one synchronization clock.

The invention will become more apparent from the following description of an embodiment taken in conjunction with the accompanying drawing, in which:

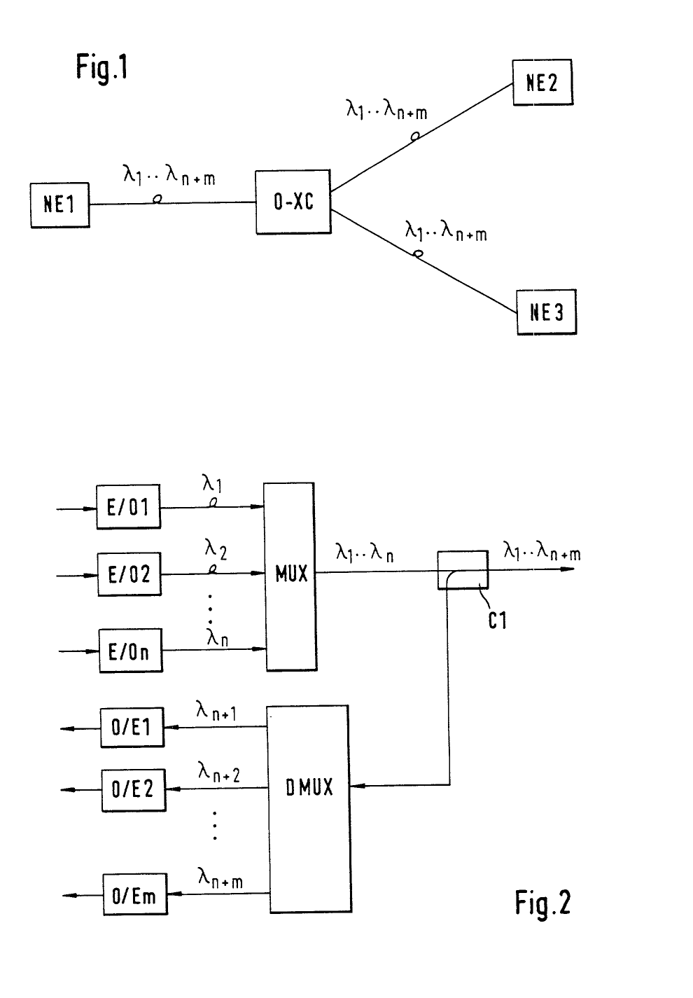

FIG. 1 is a schematic block diagram of a synchronous digital communications system according to the invention; and

FIG. 2 is a schematic block diagram of a portion of the network element NE1 of FIG. 1.

Referring to FIG. 1, a synchronous digital communications system comprises three network elements NE1, NE2, NE3, which are interconnected by optical lines. Connected between network elements NE1, NE2, NE3 is an optical cross-connect O-XC. Over the Optical lines, e.g., glass optical fibers, optical signals are transmitted using wavelength-division multiplexing (WDM) or dense wavelength-division multiplexing (DWDM). N+m wavelengths are provided. The communications system is designed as a bidirectional transmission system. Wavelengths λ₁ to λₙ are used for the transmission of signals from network element NE1 to network elements NE2, NE3. Wavelengths λₙ₊₁ to λₙ₊ₘ are used for the transmission of signals from network elements NE2, NE3 to network element NE1; n and m are natural numbers, e.g., n=20, m=20.

The communications system represents the minimum version of a system which permits WDM over switched optical connections. The invention is also readily applicable to communications systems with more than three network elements, e.g., one thousand network elements, which are interconnected by a mesh network of optical cross-connects and add/drop multiplexers, for example. Generally, the invention is applicable to any synchronous communications system which interconnects at least three electric subnetworks via an optical subnetwork such that switched optical connections are possible.

Turning now to FIG. 2, there is shown a portion of network element NE1 of FIG. 1. Network element NE1 comprises n electrical-to-optical converters E/01, E/O2, . . . , E/On and m optical-to-electrical converters O/E1, O/E2, . . . , O/Em. The n electrical-to-optical converters E/O1, E/O2, . . . , E/On serve to convert the electric signals transmitted via the interface units of network element NE1 from electrical to optical form. To that end, the first interface unit is connected to and permanently associated with electrical-to-optical converter E/O1, the second interface unit is connected to and permanently associated with electrical-to-optical converter E/O2, etc. Each electrical-to-optical converter E/O1, E/O2, . . . , E/On generates a different wavelength. All wavelengths λ₁ to λₙ are combined in a multiplexer MUX, which is implemented as an optical combiner, for example. The combined wavelengths are simultaneously transmitted over the optical network. The optical cross-connect switches optical connections and forwards the wavelengths assigned to the optical connections in accordance with their destination addresses. If, for example, information is to be transferred to network element NE2 over two optical channels, use will be made of, e.g., wavelengths λ₂ and λ₃, which will be switched through to network element NE2 by optical cross-connect O-XC. If, for example, information is to be transferred over two further optical channels to network element NE3, use will be made of, e.g., wavelengths λ₄ and λ₅, which will be switched through by optical cross-connect O-XC. In a further time period, information can, for instance, be transferred to network element NE2 at wavelengths λ₂ and λ₅ and to network element NE3 at wavelengths λ₃ and λ₄. To continuously ensure synchronization in the network, a nonswitched auxiliary optical channel is created, for example by reserving wavelength λ₁ for the exclusive transmission of auxiliary signals, such as synchronization signals. Electrical-to-optical converter E/O1 is supplied with a synchronization clock generated in a primary reference source. The synchronization clock is transmitted to network element NE2 at the reserved wavelength λ₁. Network element NE2 synchronizes itself to the incoming clock. By creating a second auxiliary channel, which is done by reserving a second wavelength, the synchronization clock can be supplied to network element NE3, which then also synchronizes itself to the incoming clock.

Network element NE1 receives information from network elements NE2 and NE3 via a fiber optic coupler C1 and a demultiplexer DMUX, which selects individual wavelengths and passes them on to optical-to-electrical converters O/E1, O/2, . . . , O/Em. Fiber optic coupler C1 extracts all wavelengths λₙ₊₁ to λₙ₊ₘ from the optical fiber; n and m may also have different values. Demultiplexer DMUX is implemented as a wavelength-dependent splitter, for example. Each optical-to-electrical converter O/E1, 0/E2, . . . , O/Em converts a different wavelength and passes the corresponding electric signal to a respective one of the interface units of network element NE1. If the master-slave approach (hierarchical synchronization) is used, all wavelengths λₙ₊₁ to λₙ₊ₙ can be used to transmit information signals. If mutual synchronization is used, wavelengths λₙ₊₁ and λₙ₊₂, for example, are reserved for the synchronization signals of network elements NE2 and NE3, respectively; the other wavelengths λₙ₊₃ to λₙ₊ₘ can then be used for the transfer of information.

If mutual synchronization is used, two, three, or four interface units of network element NE1, for example, are reserved for synchronization purposes and be permanently associated with electrical-to-optical converters and optical-to-electrical converters. The synchronization clock to be used is selected according to priority or on the basis of a higher quality of reception.

In optical network element NE2, wavelengths λ₁ to λₙ are received. These wavelengths can be transferred via optical splitters to a plurality of optical network elements, so that the information transmitted on the wavelengths is distributed by the broadcast method. In this way, the auxiliary channel, in particular, can be simultaneously transferred to a plurality of network elements. If synchronization signals are transmitted in the auxiliary channel, they will reach a plurality of network elements, which will then synchronize themselves to these synchronization signals. Alternatively, the auxiliary channel may be transferred via a suitable arrangement of splitters only to selected ports of optical network element NE2, so that the synchronization signals will, for instance, be transferred only according to the predetermined synchronization paths, for example to avoid timing loops. In a further variant, the synchronization signals received in network element NE2 over the auxiliary channel are converted from optical to electrical form. Electrical evaluation is performed using a PLL, for example. The subsequent distribution of the synchronization signals via selected or all ports of network element NE2, which synchronization signals may have been evaluated and selected from a plurality of received synchronization signals, is effected for each optical connection by electrical-to-optical conversion or via an optical combiner which, for example, adds wavelength λ₁, which is intended for the auxiliary channel, to wavelengths λ₂ to λₙ. The processing and transfer of information in network element NE2 is all-optical, for example, and that of the synchronization signals is electrical.

1. A synchronous digital communications system for optically transmitting electric signals wherein the electric signals to be transmitted are converted from electrical to optical form (E/O1, E/O2, E/On) and then transmitted using wavelength-division multiplexing,
characterized in
that using at least one wavelength (λ₁) at least one nonswitched auxiliary optical channel is created which is reserved for the transmission of synchronization signals in particular.

2. A communications system as claimed in claim 1, characterized in that the at least one auxiliary channel serves to transmit management and maintenance signals.

3. A communications system as claimed in claim 1, characterized in that at least three network elements (NE1, NE2, NE3) each comprising at least one electrical-to-optical converter (E/O1, E/O2, E/On) and at least one optical-to-electrical converter (O/E1, O/E2, O/Em) are interconnected by optical lines, that
at least one optical cross-connect (O-XC) is connected between the network elements (NE1, NE2, NE3), and that the at least one optical cross-connect (O-XC) is adapted to switch optical connections for routing signals from one network element (NE1, NE2, NE3) to another network element (NE1, NE2, NE3) using individual wavelengths (λ₂, λₙ), with the at least one auxiliary optical channel being not usable for the switched optical connections.

4. A communications system as claimed in claim 1, characterized in that at least three network elements (NE1, NE2, NE3) interconnected by optical lines are provided, that the network elements (NE1, NE2, NE3) are SDH or SONET elements, and that between the network elements (NE1, NE2, NE3), hierarchical synchronization is established by the creation of the at least one auxiliary channel for transmitting a synchronization clock generated in a primary reference source, and clocks derived therefrom, over predetermined paths.

5. A communications system as claimed in claim 1, characterized in that at least three network elements (NE1, NE2, NE3) interconnected by optical lines are provided, that the network elements (NE1, NE2, NE3) are SDH or SONET elements, and that between the network elements (NE1, NE2, NE3), mutual synchronization is established by the creation of the at least one auxiliary channel for transmitting at least one synchronization clock generated in at least one primary reference source over predetermined paths.

6. A communications system as claimed in claim 1, characterized in that at least three network elements (NE1, NE2, NE3) interconnected by optical lines are provided, that a synchronization manager and a connection manager are provided, that the synchronization manager is adapted to configure dedicated synchronization links between the three network elements (NE1, NE2, NE3) via the at least one auxiliary channel, and that the connection manager is adapted to configure communication links via switched optical connections which do not include the at least one auxiliary channel.

7. A method of optically transmitting electric signals wherein the electric signals to be transmitted are converted from electrical to optical form (E/O1, E/O2, F/On) and then transmitted using wavelength-division multiplexing,
characterized in
that using at least one wavelength (λ₁), at least one nonswitched auxiliary optical channel is created which is reserved for the transmission of synchronization signals in particular. 8. A method as claimed in claim 7, characterized in that in a synchronous communications system comprising at least three network elements (NE1, NE2, NE3) interconnected by optical lines, dedicated synchronization links between the at least three network elements (NE1, NE2, NE3) are switched over the at least one auxiliary channel for transmitting at least one synchronization clock.
